(19) United States
(12) Patent Application Publication
(10) Pub. No.: US 2025/0187946 A1
(43) Pub. Date: Jun. 12, 2025

(54) METHODS OF USE OF RECYCLED TIRE MATERIAL FOR CONTAMINANT REMOVAL

(71) Applicant: I Do TDA, Inc., Stanchfield, MN (US)

(72) Inventors: Monte Niemi, Stanchfield, MN (US); Jae Kwang Park, Verona, WI (US)

(21) Appl. No.: 18/531,838

(22) Filed: Dec. 7, 2023

(51) Int. Cl. C02F 1/28; C02F 1/56; C02F 101/10; C02F 101/16; C02F 101/20; C02F 101/32; C02F 101/36; C02F 101/38; C02F 103/00; C02F 103/06

(52) U.S. Cl. CPC C02F 1/285; C02F 1/56; C02F 2101/105; C02F 2101/163; C02F 2101/20; C02F 2101/32; C02F 2101/36; C02F 2101/38; C02F 2103/001; C02F 2103/06

(57) ABSTRACT

A method of use of recycled tires comprising providing a waste tire and/or tire-derived aggregate for use, baling said waste tire and/or tire-derived aggregate into a baled product, transporting the baled product to a secondary location, and placing the baled product at the secondary location to abate emerging contaminants and conventional contaminants at the secondary location.

### FIELD

The various embodiments herein relate to methods of use of recycled tires and tire-derived aggregate.

### BACKGROUND

Environmental contaminants, such as per- and polyfluoroalkylated substances (PFAS), N-(1,3-Dimethylbutyl)-N′-phenyl-p-phenylenediamine (6PPD), and micro-plastics and nano-plastics, can adversely impact the environment and public health.

Various methods can be used to remove such contaminants from the environment, some of which include the use of recycled materials. For example, rubber-based substances derived from recycled materials (such as, for example, tires) can be used to remove various contaminants. However, facilities that process and recycle tires can be inconveniently located for the projects that require the use of recycled tires. In addition, scrap tires can often be challenging to transport, as scrap tires are bulky in nature, making them difficult to transport in large quantities.

There is a need in the art for improved methods of transporting tire-derived aggregate and methods of use of recycled tires and tire-derived aggregate to abate contaminants.

### BRIEF SUMMARY

In an embodiment described herein, a method of use of recycled tires comprises providing a waste tire and/or tire-derived aggregate for use, baling said waste tire and/or tire-derived aggregate into a baled product, transporting the baled product to a secondary location, and placing the baled product at the secondary location to abate emerging contaminants and conventional contaminants at the secondary location.

In a further embodiment, the method further comprises packaging the baled product.

In a further embodiment, packaging the baled product comprises using a gabion or bag to package said baled product.

In a further embodiment, placing the baled product at the secondary location comprises excavating an area, situating the baled product in said area to create a situated baled product, and filling in said area with a layer of soil.

In a further embodiment, the method further comprises a conduit formed by a continuous channel between a plurality of baled products.

In a further embodiment, the conduit comprises loose tire chips, rock aggregate, clean fill, sugar sand, coir, enhanced iron sand, compost, wood chips, foamed glass, biochar, flexible drain tile, anionic resins, granulated activated carbon, any pipe, or any stormwater chamber.

In a further embodiment, the tire-derived aggregate comprises raspy.

In a further embodiment, the emerging contaminants comprise PFAS-related chemicals, 6PPD-related chemicals, microplastics, and/or nanoplastics.

In a further embodiment, the conventional contaminants comprise heavy metals, nitrate, phosphorous, sewage, oils, grease, pesticides, and synthetic organic compounds.

In a further embodiment, the situated baled product comprises a layer of the baled product having a length ranging from 0.5 inch to 50 feet.

In a further embodiment, the secondary location includes a course of water.

In another embodiment described herein, a method of abating contaminants using recycled tires comprises providing a waste tire and/or tire-derived aggregate for use, baling said waste tire and/or tire-derived aggregate into a baled product transporting the baled product to a secondary location, and placing the baled product at the secondary location to abate emerging contaminants and conventional contaminants at the secondary location.

In a further embodiment, the emerging contaminants comprise 6PPD-related chemicals, the 6PPD-related chemicals being abated by sorption.

In a further embodiment, the emerging contaminants comprise PFAS-related chemicals, the PFAS-related chemicals being abated by reductive defluorination, biomass growth medium, sorption, and/or chemical precipitation.

In a further embodiment, the emerging contaminants comprise microplastics and/or nanoplastics, the microplastics and/or nanoplastics being abated using sorption and/or filtration.

In a further embodiment, the conventional contaminant comprises heavy metals, the heavy metals being abated by sorption.

In a further embodiment, the conventional contaminant comprises nitrate, the nitrate being abated by sorption and/or biodegradation.

In a further embodiment, the baled product comprises steel wire-rich raspy, the conventional contaminant comprises phosphorous, the phosphorous being abated by precipitation.

In a further embodiment, the conventional contaminant comprises oil or grease and the baled product comprises sorption capacity recoverable by biodegradation, the oil or grease being abated by sorption.

In a further embodiment, the conventional contaminants comprise synthetic organic compounds, the synthetic organic compounds being abated by sorption.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a flow chart of a method of use of recycled tires, in accordance with one or more examples of this disclosure.

FIG. 2A is a perspective view of baled recycled tire-derived aggregate, in accordance with one or more examples in this disclosure.

FIG. 2B is a close-up perspective view of baled recycled tire-derived aggregate, in accordance with one or more examples of this disclosure.

FIG. 3 is a close-up perspective view of packaging for baled tire-derived aggregate, in accordance with one or more examples of this disclosure.

FIG. 4 is a perspective view of baled recycled tire-derived aggregate, in accordance with one or more examples of this disclosure.

FIG. 5A is a perspective view of tire-derived aggregate in use, in accordance with one or more examples of this disclosure.

FIG. 5B is a side view of tire-derived aggregate in use, in accordance with one or more examples of this disclosure.

FIG. 5C is a side view of tire-derived aggregate in use, in accordance with one or more examples of this disclosure.

FIG. 6 is perspective view of tire-derived aggregate in use, in accordance with one or more examples of this disclosure.

FIG. 7 is a top-down view of raspy, in accordance with one or more examples of this disclosure.

### DETAILED DESCRIPTION

The embodiments herein are directed to a method of use of recycled tires and tire-derived aggregate, or TDA. In particular, the methods herein are directed to the use of recycled tires, and/or tire-derived aggregate, to abate various contaminants and/or nano- or microplastics. The methods described herein are also directed to a method of transportation of recycled tires and/or tire-derived aggregate.

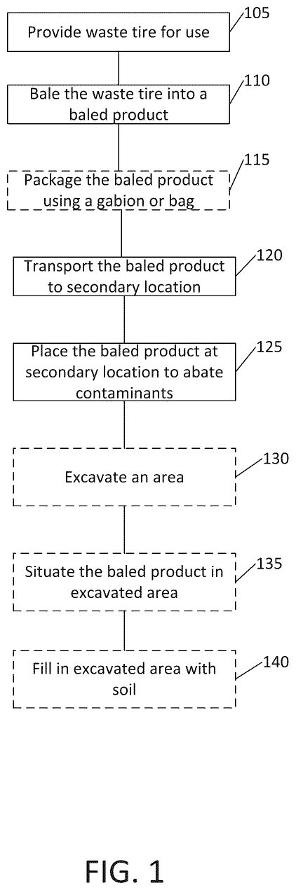

The embodiments herein are directed to a method of transportation and use of recycled tires and tire-derived aggregate, as best shown in FIG. 1. The method includes providing a waste tire and/or tire-derived aggregate for use (105), baling said waste tire and/or tire-derived aggregate into a baled product (110), transporting the baled product to a secondary location (120), and placing the baled product at the secondary location to abate emerging contaminants and conventional contaminants at the secondary location (125). Because tire processing facilities can be located in inconvenient locations and recycled tires can be difficult to transport, baling the recycled tire can increase the ease of transport of recycled tires such that they may be used at locations distant from the tire processing facilities to abate contaminants. This process can also reduce the amount of space needed to transport the recycled tires, as a greater amount of space may be needed to transport scrap tire in comparison to the space needed to transport baled recycled tires.

Tires to be recycled can be recycled into various types of recycled products. These can be classified using a variety of terms established by the American Society for Testing and Materials (ASTM), summarized in Table 1 below:

TABLE 1

| | | |
|---|---|---|
| | Upper Limit, | Lower Limit, |
| Term Name | inches (mm) | inches (mm) |

| | |
|---|---|
| Chopped Tire | Cut into relatively large pieces of |
| | unspecified dimensions |

| | | |
|---|---|---|
| Rough Shred | 1.97 × 1.97 × 1.97 | 30.0 × 1.97 × 3.94 |
| | (50 × 50 × 50) | (762 × 50 × 100) |

| | | | | |
|---|---|---|---|---|
| Tire Derived | 12 | (305) | 0.47 | (12) |
| Aggregate (TDA) | | | | |
| Tire Shreds | 12 | (305) | 1.97 | (50) |
| Tire Chips | 1.97 | (50) | 0.47 | (12) |
| Granulated Rubber | 0.47 | (12) | 0.017 | (0.425) |
| Ground Rubber | <0.47 | (<12) | <0.017 | (0.425) |

| | | | |
|---|---|---|---|
| Powdered Rubber | — | ≤0.017 | (0.425) |

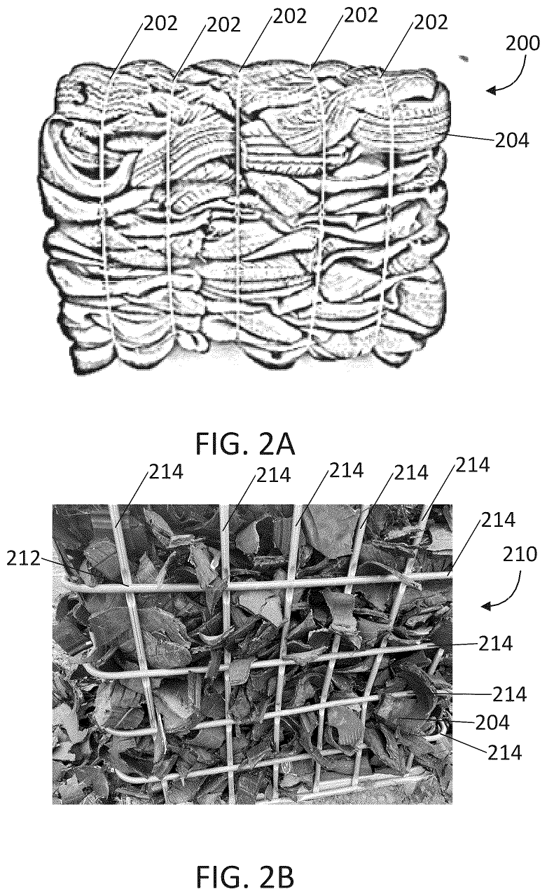

The baled product can be packaged in a variety of ways. In a further embodiment of the method, the method can include packaging the baled product (115). In a further embodiment of the method, packaging the baled product can include using a gabion 200 or bag 232, 252 to package said baled product, as shown in FIGS. 2A and 2B. The embodiment 200 of FIG. 2A shows tire-derived aggregate 204 packaged using a cord 202. Tire-derived aggregate 204 can be packaged using a plurality of cords 202. The cords 202 can be spaced depending on the size of the tire-derived aggregate 204 such that the cords 202 maintain the tire-derived aggregate 204 in a its baled configuration.

FIG. 2B shows a close-up view of an embodiment 210 including tire-derived aggregate 204 packaged in a different gabion 212. In some embodiments, the gabion 212 can include a plurality or vertical and/or horizontal bars 214 configured to contain the tire-derived aggregate 204. In some embodiments, some portions of the tire-derived aggregate 204 may protrude from between the horizontal and/or vertical bars 214 of the gabion 212. The horizontal and/or vertical bars 214 of the gabion 212 can be rigid. In other embodiments, the horizontal and/or vertical bars 214 can be flexible.

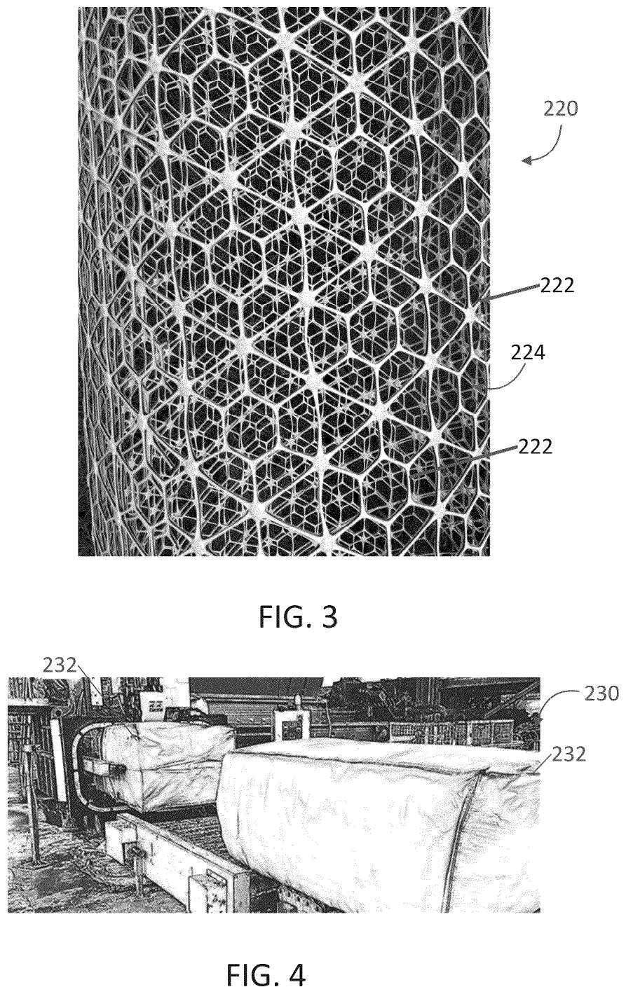

FIG. 3 shows a close-up perspective view of an embodiment of the gabion 220. The gabion 220 can be a mesh 220. In some embodiments, the mesh 220 can be made of metal. The metal mesh 220 can be a wire mesh 220. The wire mesh 220 can be flexible. This can allow a user to use tire-derived aggregate packaged in a flexible mesh 220 in a variety of applications. Different applications of TDA can require that the TDA be packed in different shapes configured for specific uses and/or locations. The gabion 220 can be shaped into a cage, cylinder, or box, for example.

The mesh 220 can include a variety of features. For example, the structures 222 forming the mesh 220 can be bars 222. The bars 222 of the mesh 220 can be used to form a variety of shapes. For example, the bars 222 can be vertical or horizontal in some embodiments. In other embodiments, such as that of FIG. 3, the bars 222 can be disposed in a web-like configuration. The bars 222 of the mesh 220 can be curved and/or straight. The bars 222 of the mesh 220 can form various shapes. In some embodiments, the bars 222 of the mesh 220 can form a pattern. In other embodiments, the bars 222 of the mesh 220 can be disposed such that there is no pattern to their disposition. The space 224 between the bars 222 can allow the passage of a fluid therethrough. The various patterns of the mesh 220 can be configured for use with varying types and/or sizes of recycled tires. For example, larger mesh sizes can accommodate larger pieces of recycled tires. Smaller mesh sizes can accommodate smaller pieces of recycled tires. The mesh sizes can be configured to provide greater accessibility by fluid to the contents therein. In the applications described herein, the mesh sizes can be configured to reduce disruptions (such as obstructions) to the flow of water to the recycled tire.

The baled product can be packaged in any known means of packaging for recycled tires. FIG. 4 shows an alternative means of packaging the recycled tire including a textile. The bag 230 holding the baled product can be a water-permeable geotextile 232. In other embodiments, the bag 230 can be any known fabric bag. The baled product can be packaged in any shape configured for use. The textile can be prepared (i.e., sewn) into a pre-determined shape configured to receive the baled product.

Returning to FIG. 1, various actions can be taken to place the baled product at a secondary location (125). In a further embodiment, placing the baled product at the secondary location can include excavating an area (130), situating the baled product in said excavated area to create a situated baled product (135), and filling in said excavated area with a layer of soil (140). The excavated area can be any size to accommodate any number of baled products. The size of the excavated area can be modified depending on the shape of the baled product. In a further embodiment of the method, the situated baled product can include a layer of baled product having a length ranging from 0.5 inch to 50 feet. In a further embodiment of the method, the secondary location can include a course of water.

The baled product can be placed at secondary locations. For example, the baled product can be incorporated into various civil engineering applications. In some examples, the baled product can be used as a drainage medium for stormwater retention/detention, frost heave prevention under roads, reduction of lateral loads on retaining walls, reinforcement of bridge abutments and embankments, stabilizing slopes, thermally insulating roadways and exterior basement walls, and vibration damping (mitigation) for railways or airport runways.

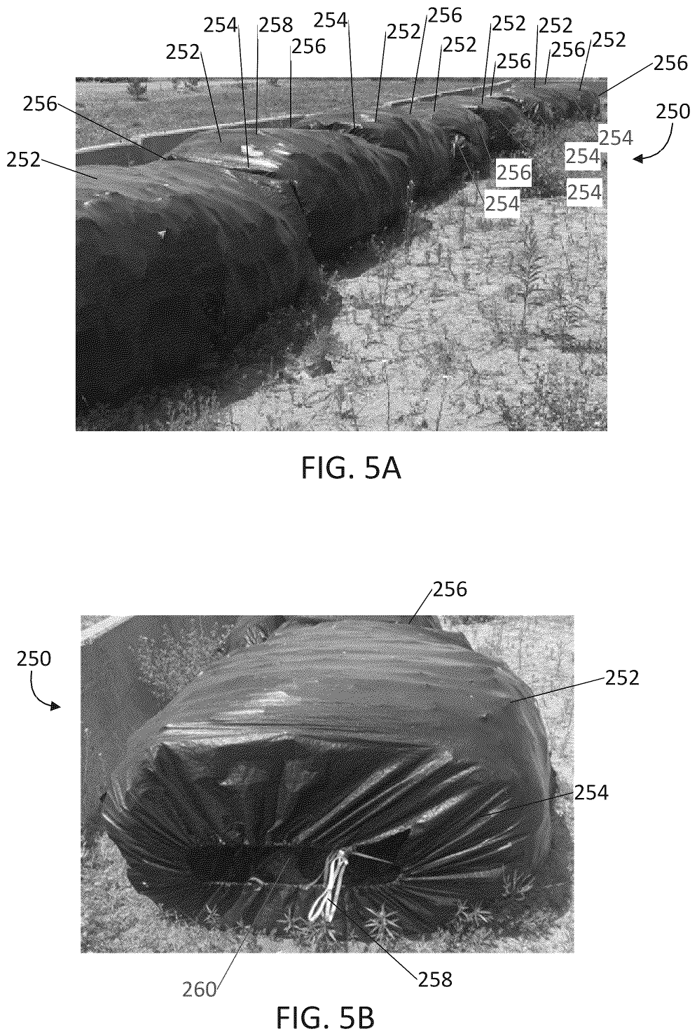

FIG. 5A shows a series of bagged recycled tires 250. Each bag of recycled tire 252 can have a first end 254 and a second end 256, and a plurality of sides 255 longer than the first and second ends 254, 256. In some embodiments, each bag 252 of recycled tire can be positioned such that the first or second end 254, 256 of one bag 252 is adjacent the first or second end 254, 256 of an adjacent bag 252. In other embodiments, the bags 252 containing recycled tires can be positioned side by side, such that a side 255 is positioned adjacent to a side 255 of an adjacent bag 252 containing recycled tire.

The bag can be sealed in a variety of ways. FIG. 5B shows a sealed bag 252 containing recycled tire 260. In some embodiments, the bag 252 can be sealed using a rope, string, wire, twine, or any known means of tying. In some embodiments, the bag 252 can be sealed using a drawstring 258. The drawstring 258 can be made of any material, including, for example, cloth and/or plastic. In other embodiments, the bag can be sewn shut or heat sealed (not pictured). The bag 252 can be sealed using a fastener in other embodiments. In some examples, the bag 252 can be sealed using zippers, buttons, snap fasteners, a hook-and-loop system, or a strap to tie the fabric closed around the recycled tire material. In other embodiments, the bag can be sealed using any known fastener. The portion of the bag 252 including the seal 258 can be the first end 254 of the bag 252.

FIG. 5C shows a side view of a bag 252. The bag 252 can include a side wall 255 extending from the first end 254 to the second end 256. In some embodiments, the side wall 255 does not include the sealing components of the bag 252.

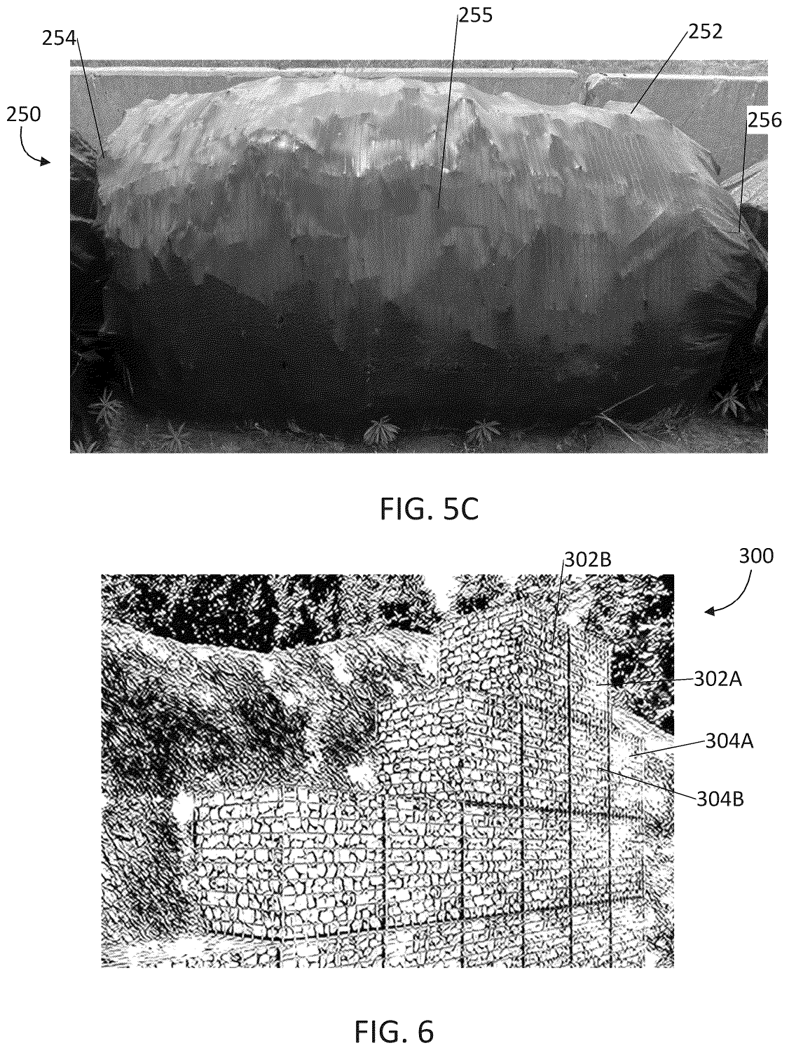

The baled product can be placed in a variety of configurations. Such an exemplary configuration 300 is shown in FIG. 6. In some examples, the baled product can be placed individually at a location. In other examples, the baled product can be staggered, or in succession in a continuous row. Rows can be formed by placing the baled blocks 302A, 302B side-by-side in any configuration. The baled product can be stacked atop adjacent baled product 304A, 304B. The baled product(s) can be disposed in any known configuration configured for use in mitigation and/or abatement of various contaminants.

In some embodiments, the baled product can be a block, as shown bagged in FIG. 6. The block can be approximately about 30″×about 50″ to about 54″×about 60.″ The dimensions of the block 220 can vary depending on the baler used to create the block. The bag 220 or gabion 200 can also include materials other than recycled tires. In some embodiments, the bag 220 or gabion 200 can include metal wire, soils, sands, rocks, coir, foamed glass, or other tire parts (not pictured). The bag 220 or gabion 200 can include any known material configured for use with recycled tires. The other materials can be used in combination with the recycled tire to remove contaminants.

In a further embodiment of the method, the method can include a conduit formed by a continuous channel between a plurality of baled products (not pictured). The conduit can create a uniform chamber continuity between multiple baled blocks. In a further embodiment of the method, the conduit can include loose tire chips, rock aggregate, clean fill, sugar sand, coir, enhanced iron sand, compost, wood chips, foamed glass, biochar, flexible drain tile, anionic resins or granular carbon, any pipe, or any stormwater chamber. In other embodiments, the conduit material can be any flexible drain tile, PVC pipe, cement pipe, or any other known pipe. The conduit material can be any known fabricated stormwater chamber in other embodiments. The anionic resins or granular carbon can be used to remove PFAS. In some embodiments, the PFAS can be removed to an undetectable level. The detection limit for these chemicals can range from 0.4 parts per trillion to 2.7 parts per trillion.

The baled product can be used to abate a variety of contaminants. In a further embodiment of the method, the emerging contaminants can include PFAS-related chemicals, 6PPD-related chemicals, microplastics, and/or nanoplastics. In a further embodiment of the method, the conventional contaminants can include heavy metals, nitrate, phosphorous, sewage, oils, grease, pesticides, and synthetic organic compounds.

In some embodiments of the method, the emerging contaminants can include 6PPD-related chemicals. The 6PPD-related chemicals can be abated by sorption. Tire-derived aggregate can be used to abate 6PPD-related chemicals alone and/or in combination with sand, forming a sand-TDA mixture. The tire-derived aggregate and/or tire-derived aggregate-sand mixture can be disposed in soil containing organic matter. In such an embodiment, the TDA can include ferric material(s). In some embodiments, the ferric material(s) can be steel wires. In some embodiments, the TDA can include approximately 75% to 80% organic carbon material and approximately 10% to 15% ferric material(s). In some embodiments, the TDA can attract long-chain non-polar organic chemicals, adsorb heavy metals and/or organic compounds, degrade halogenated compounds, and precipitate nitrates.

In a further embodiment of the method, the emerging contaminants can include PFAS-related chemicals. The PFAS-related chemicals can be abated by reductive defluorination, biomass growth medium, sorption, and/or chemical precipitation. PFAS can be defluorinated by iron and zinc present in steel wires of TDA and TDA rubber as reducing agents. Therefore, TDA provides strains of certain autotrophic bacteria growth conditions in surrounding soil which, in turn, can degrade PFAS-related chemicals. Thus, in the presence of PFAS chemicals, the biofilm growing on the surface of TDA and organic-matter-rich soil surrounding TDA-baled blocks will allow PFAS-consuming anaerobic bacterial culture growth. As a result, these cultures would defluorinate PFAS chemicals from runoff.

Overall, through combined mechanisms of zero-valent metal reductive dehalogenation, biotically-generated hydrogen reductive halogenation, biological degradation by autotrophic and other PFAS-consuming anaerobic bacteria attached to the TDA surface, and sorption of PFAS-related chemicals onto TDA rubber, it is anticipated that TDA-baled blocks can remove more than 50% of PFOA and PFAS chemicals from landfill leachate, composting facility runoff, and other stormwater collection and infiltration systems.

In a further embodiment of the method, the emerging contaminants can include microplastics and/or nanoplastics. The microplastics and/or nanoplastics can be abated by sorption and/or filtration. Nano-plastics are lipophilic in nature and thus can be dissolved in fats, oils, lipids, and non-polar solvents.

A sand-TDA mixture layer can address the micro-plastic and nano-plastic pollution from runoff. A TDA layer (coarse aggregate) on top of a TDA-sand mix layer (fine aggregate) can provide a dual-filtration system. The top, coarse TDA layer material can serve as a first step micro-plastic and nano-plastic removal filter, having greater void space than the underlying TDA-sand mix layer. TDA is a non-polar material that can attract and dissolve other non-polar materials such as nano-plastics, and remove micro and nano-plastics via a sorption mechanism. Moreover, TDA also absorbs fat, oil, and grease, attracting and dissolving lipophilic material such as nano-plastics. The continuous growth of naturally regenerative biofilm within the compacted TDA medium can enhance TDA's capacity to dissolve and remove the nano-plastics from runoff. The bottom layer with a fine TDA-sand mixture can remove micro-plastics from stormwater by filtration. The TDA-sand mix layer can trap bigger-sized microplastics. A combination of sand and TDA can filter microplastics. The sand can have varying grain sizes. In some embodiments, the sand can have a 0.5 mm grain size.

TDA can also be used to other contaminants. In a further embodiment of the method, the conventional contaminant can include heavy metals. The heavy metals can be abated by sorption. TDA can remove heavy metals by ion exchange and adsorption.

TDA can be used to abate nitrates. In a further embodiment of the method, the conventional contaminant can include nitrate. The nitrate can be abated by sorption and/or biodegradation. Thus, shredded tires can be installed in buffer zones around agricultural lands as trenches or berms for nitrate removal. The removal mechanisms are sorption and microbial activity.

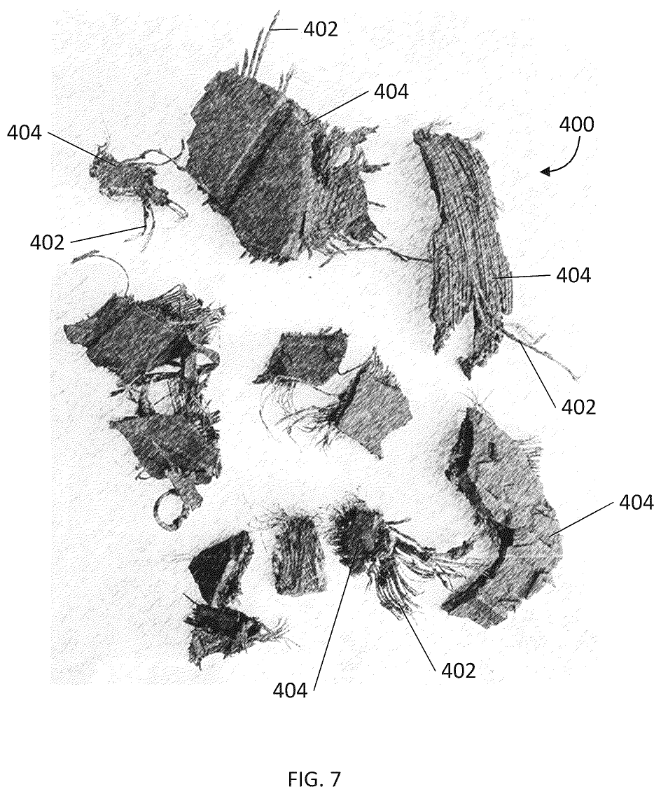

The tire-derived aggregate can include a variety of tire-derived products. In a further embodiment of the method, the tire-derived aggregate can include raspy 400, as shown in FIG. 7. The pieces of raspy 400 can vary in size. In a further embodiment of the method, the baled product can include steel wire-rich raspy. The steel wire 402 can protrude from the body 404 of the raspy 400. The conventional contaminant can be phosphorous. The phosphorous can be abated by precipitation.

Other contaminants can include oil and/or grease. In a further embodiment of the method, the conventional contaminant can include oil and/or grease. The oil and/or grease can be abated by sorption.

In a further embodiment of the method, the conventional contaminants can include synthetic organic compounds. Synthetic organic compounds can be abated by sorption.

In some embodiments, the baled product can be configured for use as a runoff collection system. This system can be used in applications with highway roads and bridges. In this embodiment, the system can be placed adjacent to a road or adjacent to a low-lying area. In other embodiments, the baled product can be used in applications for decentralized on-site wastewater treatment/septic systems, mound septic systems, recirculating sand filter septic systems, evapotranspiration septic systems, constructed wetland septic systems, cluster/community septic systems, landfill leachate collection systems, landfill leachate recirculation systems, landfill gas collection trenches, and vertical holes, buffer zones to protect watershed in agricultural lands, golf courses, and drinking water source areas, rain gardens, berms constructed for perimeter control of runoff, filtration socks, agricultural runoff treatment systems, golf course runoff treatment systems, and other potential applications.

While the various systems described above are separate implementations, any of the individual components, mechanisms, or devices, and related features and functionality, within the various system embodiments described in detail above can be incorporated into any of the other system embodiments herein.

The term “about,” as used herein, refers to variation in the numerical quantity that can occur, for example, through typical measuring techniques and equipment, with respect to any quantifiable variable, including, but not limited to, mass, volume, time, distance, wavelength, frequency, voltage, current, and electromagnetic field. Further, there is certain inadvertent error and variation in the real world that is likely through differences in the manufacture, source, or precision of the components used to make the various components or carry out the methods and the like. The term “about” also encompasses these variations. The term “about” can include any variation of 5% or 10%, or any amount—including any integer—between 0% and 10%. Further, whether or not modified by the term “about,” the claims include equivalents to the quantities or amounts.

Numeric ranges recited within the specification include the numbers defining the range and each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, a description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A method of use of recycled tires, comprising:
providing a waste tire and/or tire-derived aggregate for use;
baling said waste tire and/or tire-derived aggregate into a baled product;
transporting the baled product to a secondary location; and
placing the baled product at the secondary location to abate emerging contaminants and conventional contaminants at the secondary location.

2. The method of use of recycled tires of claim 1, further comprising packaging the baled product.

3. The method of use of recycled tires of claim 2, wherein packaging the baled product comprises using a gabion or bag to package said baled product.

4. The method of use of recycled tires of claim 1, wherein placing the baled product at the secondary location comprises:
excavating an area;
situating the baled product in said area to create a situated baled product; and
filling in said area with a layer of soil.

5. The method of use of recycled tires of claim 1, further comprising a conduit formed by a continuous channel between a plurality of baled products.

6. The method of use of recycled tires of claim 5, wherein the conduit comprises loose tire chips, rock aggregate, clean fill, sugar sand, coir, enhanced iron sand, compost, wood chips, foamed glass, biochar, flexible drain tile, anionic resins or granular activated carbon, any pipe, or any stormwater chamber.

7. The method of use of recycled tires of claim 1, wherein the tire-derived aggregate comprises raspy.

8. The method of use of recycled tires of claim 1, wherein the emerging contaminants comprise PFAS-related chemicals, 6PPD-related chemicals, microplastics, and/or nanoplastics.

9. The method of use of recycled tires of claim 1, wherein the conventional contaminants comprise heavy metals, nitrate, phosphorous, sewage, oils, grease, pesticides, and synthetic organic compounds.

10. The method of use of recycled tires of claim 4, wherein the situated baled product comprises a layer of the baled product having a length ranging from 0.5 inch to 50 feet.

11. The method of use of recycled tires of claim 4, wherein the secondary location includes a course of water.

12. A method of abating contaminants using recycled tires, comprising:
providing a waste tire and/or tire-derived aggregate for use;
baling said waste tire and/or tire-derived aggregate into a baled product;
transporting the baled product to a secondary location;
placing the baled product at the secondary location to abate emerging contaminants and conventional contaminants at the secondary location.

13. The method of abating contaminants of claim 12, wherein the emerging contaminants comprise 6PPD-related chemicals, the 6PPD-related chemicals being abated by sorption.

14. The method of abating contaminants of claim 12, wherein the emerging contaminants comprise PFAS-related chemicals, the PFAS-related chemicals being abated by reductive defluorination, biomass growth medium, sorption, and/or chemical precipitation.

15. The method of abating contaminants of claim 12, wherein the emerging contaminants comprise microplastics and/or nanoplastics, the microplastics and/or nanoplastics being abated by sorption and/or filtration.

16. The method of abating contaminants of claim 12, wherein the conventional contaminant comprises heavy metals, the heavy metals being abated by sorption.

17. The method of abating contaminants of claim 12, wherein the conventional contaminant comprises nitrate, the nitrate being abated by sorption and/or biodegradation.

18. The method of abating contaminants of claim 12, wherein the baled product comprises steel wire-rich raspy, the conventional contaminant comprises phosphorous, the phosphorous being abated by precipitation.

19. The method of abating contaminants of claim 12, wherein the conventional contaminant comprises oil and/or grease and the baled product comprises a sorption capacity recoverable by biodegradation, the oil and/or grease being abated by sorption.

20. The method of abating contaminants of claim 12, wherein the conventional contaminants comprise synthetic organic compounds, the synthetic organic compounds being abated by sorption.
